(19) United States
(12) Patent Application Publication
(10) Pub. No.: US 2009/0119108 A1
(43) Pub. Date: May 7, 2009

(54) AUDIO-BOOK PLAYBACK METHOD AND APPARATUS

(75) Inventors: Tae-kwon NOH, Uiwang-si (KR); young-gyoo Choi, Yongin-si (KR); Young-min Park, Yongin-si (KR)

Correspondence Address: STANZIONE & KIM, LLP, 919 18TH STREET, N.W., SUITE 440, WASHINGTON, DC, 20006, US

(73) Assignee: Samsung Electronics co., Ltd., Suwon-si (KR)

(21) Appl. No.: 12/131,259

(22) Filed: Jun. 2, 2008

(30) Foreign Application Priority Data
Nov. 7, 2007 (KR) 2007-113190

(51) Int. Cl. G10L 13/08

(52) U.S. Cl. 704/260

(57) ABSTRACT

An audio-book playback method includes buffering text data that is to be played back by speech, converting the buffered text data to speech data, performing speech-playback by using the speech data, and buffering next text data for continuous playback. The provided audio-book playback method and an apparatus enable a user to enjoy reading a book while also listening to content of the book being voiced by a multimedia playback device. Moreover, double buffering technology is employed to provide seamless text and speech-playback services.

### CROSS-REFERENCE TO RELATED APPLICATIONS

This application claims priority under 35 U.S.C. §119(a) from Korean Patent Application No. 10-2007-0113190, filed on Nov. 7, 2007, in the Korean Intellectual Property Office, the disclosure of which is incorporated herein in its entirety by reference.

### BACKGROUND OF THE INVENTION

1. Field of the Invention

The present general inventive concept relates to an audio-book, and more particularly, to an audio-book playback method and apparatus to provide a text-playback mode and a speech-playback mode simultaneously when an audio-book is played back.

2. Description of the Related Art

Conventional portable multimedia playback devices such as MP3 players mainly focus on playback of either an animated picture file or an audio file. However, recent portable multimedia playback devices further include a text-viewer function and thus contents of various books may be visually communicated to a user in either a textual or visual form.

Meanwhile, due to development of text-to-speech (TTS) conversion technology, a user can easily convert text data to speech data (or voice data), so that the user can ‘read’ a book not only visually but also aurally.

However, conventional portable multimedia playback devices fail to provide a convenient and efficient audio-book function providing merits of both the text viewer and the TTS conversion technology.

### SUMMARY OF THE INVENTION

The present general inventive concept provides an audio-book playback method and apparatus to provide both a text viewer function and a book teller function to enable a user to read a book more conveniently and efficiently.

The present general inventive concept also provides a user being able to read a book while also listening to the content of the book being voiced by a portable multimedia playback device by using the audio-book playback method and apparatus.

The present general inventive concept also provides a seamless text/speech-playback mode by employing a double buffering technology.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an audio-book playback method including buffering text data that is to be played back by speech, converting the buffered text data to speech data, performing speech-playback by using the speech data, and buffering next text data that is to be played back by speech.

The foregoing and/or other aspects and utilities of the general inventive concept may also be achieved by providing an audio-book playback method including selecting an audio-book playback mode, and performing one of a text-playback operation, a speech-playback operation, and a text and speech playback operation based on the selection.

The foregoing and/or other aspects and utilities of the general inventive concept may also be achieved by providing a computer-readable recordable medium having embodied thereon a computer program to execute a method, wherein the method including buffering of text data that is to be played back by speech, converting of the buffered text data to speech data, performing of speech-playback using the converted speech data, and buffering of next text data.

The foregoing and/or other aspects and utilities of the general inventive concept may also be achieved by providing an audio-book playback apparatus including a display to display text data, a buffer to buffer text data that is to be played back by speech, and a TTS converter to convert the text data stored in the buffer to speech data, and the apparatus outputs the text data and converted speech data simultaneously with buffering text data that is to be played back next.

The foregoing and/or other aspects and utilities of the general inventive concept may also be achieved by providing an audio-book playback apparatus having a display and a speaker, the apparatus including a text-viewer function to provide text data to the display to be displayed to a user, and a book teller function to provide speech data corresponding to the text data to the speaker to be transmitted to the user, wherein the text data is displayed by the display and the speech data is transmitted by the speaker simultaneously.

The audio-book playback apparatus may further include a buffer to buffer a next set of text data and speech data while a previous set of text data and the speech data are being respectively displayed and transmitted.

The foregoing and/or other aspects and utilities of the general inventive concept may also be achieved by providing a method of playing back an audio book, the method including providing text data to be displayed to a user, and providing speech data corresponding to the text data to be transmitted to the user such that the text data is displayed and the speech data is transmitted simultaneously.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a block diagram illustrating a physical configuration of an audio-book playback apparatus according to an embodiment of the present general inventive concept;

FIG. 2 is a flowchart illustrating an audio-book playback method according to an embodiment of the present general inventive concept;

FIG. 3 is a flowchart illustrating an audio-book speech-playback operation illustrated in FIG. 2;

FIG. 4 is a detailed flowchart of the audio-book speech-playback operation illustrated in FIG. 2;

FIGS. 5A-5H are examples of a graphic user interface (GUI) through which the audio-book playback methods illustrated in FIGS. 2 and 4 are implemented;

FIG. 6 is a flowchart illustrating an audio-book playback method according to another embodiment of the present general inventive concept; and

FIG. 7 is an example of a GUI through which the audio-book playback method illustrated in FIG. 6 is implemented.

### DETAILED DESCRIPTION OF THE PREFERRED EMBODIMENTS

The present general inventive concept will now be described more fully with reference to the accompanying drawings, in which exemplary embodiments of the general inventive concept are illustrated.

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

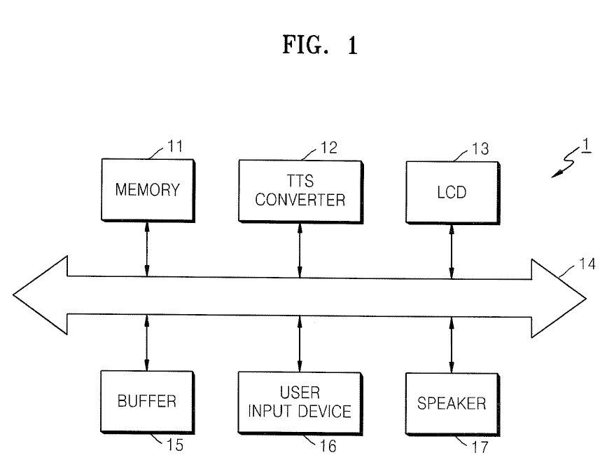

FIG. 1 is a block diagram illustrating a physical configuration of an audio-book playback apparatus according to an embodiment of the present general inventive concept.

The audio-book playback apparatus 1 includes a memory 11, a text-to-speech (TTS) converter 12, a liquid crystal display (LCD) 13, a data bus 14, a buffer 15, a user input device 16, and a speaker 17.

The LCD 13 displays a text viewer program, and the buffer 15 buffers text data of a page that is to be played back by speech.

The TTS converter 12 converts the text data stored in the buffer 15 to speech data, and the speaker 17 outputs the converted speech data. The user input device 16 denotes a remote control having keys, such as a menu key, directional keys, and a confirm key, or a control panel.

The audio-book playback apparatus 1 plays back text data and speech data and simultaneously buffers and/or converts next text data. Detailed functions of components of the audio-book playback apparatus will now be described in greater detail.

While the audio-book playback apparatus 1 may be embodied as an independent electronic device, the audio-book playback apparatus 1 may also be embodied as a portion of a portable multimedia playback device such as an MP3 player, a portable multimedia player (PMP), a personal digital assistant (PDA), or a cellular phone.

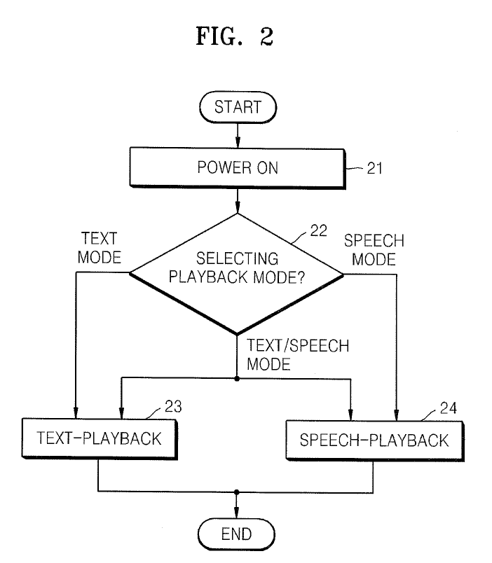

FIG. 2 is a flowchart illustrating an audio-book playback method according to an embodiment of the present general inventive concept.

Referring to FIG. 2, a user turns the audio-book playback apparatus 1 on (operation 21), and selects an audio-book playback mode (operation 22). User-selectable audio-book playback modes can be, for example, a text-playback mode, a speech-playback mode, and a text/speech-playback mode.

If the user selected the text-playback mode in operation 22, the audio-book playback apparatus 1 only performs text-playback (operation 23). Meanwhile, if the speech-playback mode is selected, the audio-book playback apparatus 1 performs only speech-playback (operation 24). Also, if the text/speech-playback mode is selected, the text-playback and the speech-playback are simultaneously performed in operation 23 and operation 24, respectively.

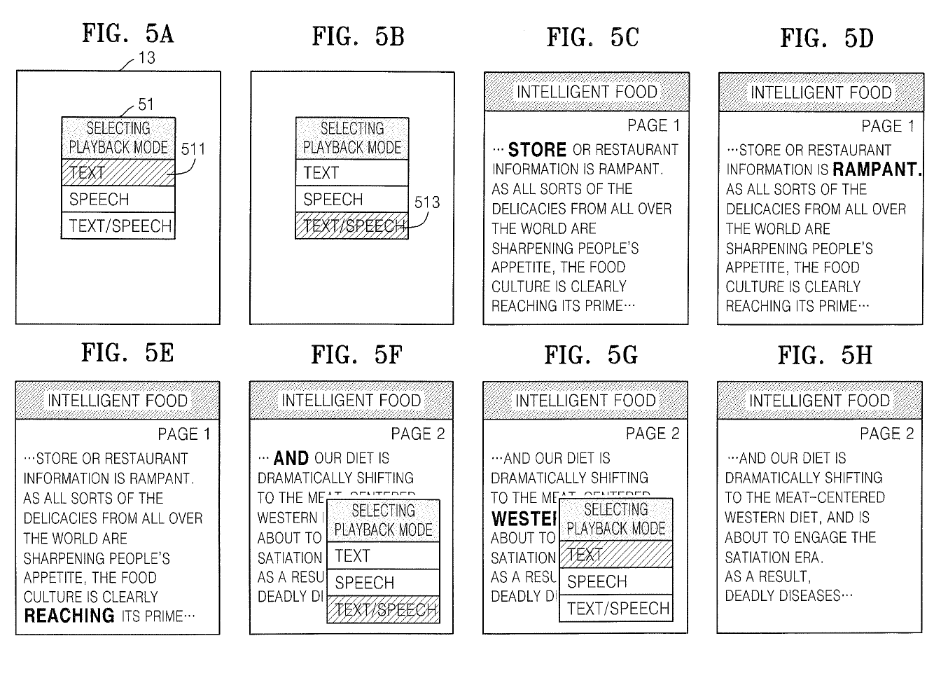

FIGS. 5A and 5B illustrate graphic user interfaces (GUIs) through which the audio-book playback mode selecting operation 22 is implemented. If a user presses the menu key included in the user input device 16 of the audio-book playback apparatus 1, a playback mode selecting window 51 is displayed on the LCD (or a text viewer) 13.

Referring to FIG. 5A, a current playback mode is set to a text-playback mode 511. If a user wants to select a text/speech-playback mode 513 as the audio-book playback mode, the user needs to press directional keys included in the user input device 16 so as to relocate a cursor in the playback mode selecting window 51 to the text/speech-playback mode 513 and press the confirm key as illustrated in FIG. 5B.

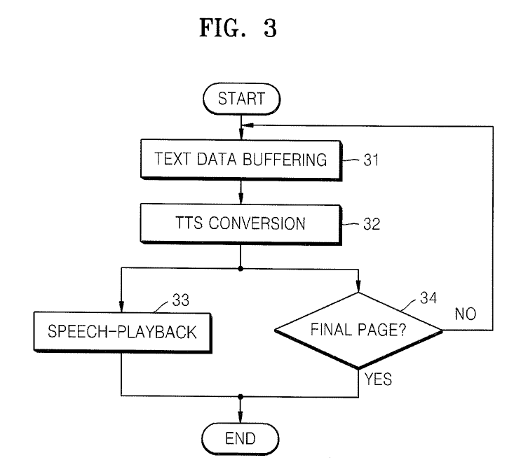

FIG. 3 is a flowchart illustrating detailed operations of speech-playback operation 24 illustrated in FIG. 2.

Referring to FIG. 3, the audio-book playback apparatus 1 buffers a portion of text data included in an audio-book file in the buffer memory 15 (operation 31).

The buffered text data is converted to corresponding speech data by performing TTS conversion (operation 32). The speech data has an audio file format from among one or more audio file formats, such as MP3, Windows Media Audio (WMA), and OGG. A format in which seamless playing and real time playing are guaranteed, for example, can be used. Also, factors such as the processing capability of the TTS converter 12, and storage capacities of the memory 11 and the buffer 15, etc. should be considered in selecting the audio file format.

The speech data is played back via the speaker 17 (operation 33). At this point, text displayed on the LCD 13 and the voice output via the speaker 17 can be synchronized.

Once speech-playback begins, the audio-book playback apparatus 1 determines whether data currently in playback is the last data of the audio-book file (operation 34).

If the data currently in playback is the last data, the speech-playback is terminated. However, if the data currently in playback is not the last data, the audio-book playback apparatus 1 returns to operation 31 and buffers a certain amount of text data next to the data currently in playback in the buffer 15.

Buffering of the next text data in operation 31 may be performed while the current data speech-playback operation 33 is being performed, which is so-called “double buffering.” Moreover, the TTS conversion of the next text data in operation 32 may also be performed while the speech-playback operation 33 of the current data is being performed. This enables seamless audio-book playback. That is, the buffering of the next text data should start before data currently being buffered is completely played back.

An amount of current data or next data buffered in operation 31 should be determined such that seamless playback of the data can be guaranteed.

Referring to FIGS. 1 and 3, the amount of data to be buffered each time should be determined in consideration of factors such as the processing capability of the TTS converter 12, the storage capacities of the memory 11 and the buffer 15, and an amount of data displayable on the LCD (or a text viewer) 13 at once.

Hereinafter, an embodiment wherein the text-playback operation 23 and the speech-playback operation 24 are simultaneously performed when the text/speech-playback mode 513 has been selected by the user in operation 22 of FIG. 2 will be described with reference to FIGS. 2, 4, and 5A-5H.

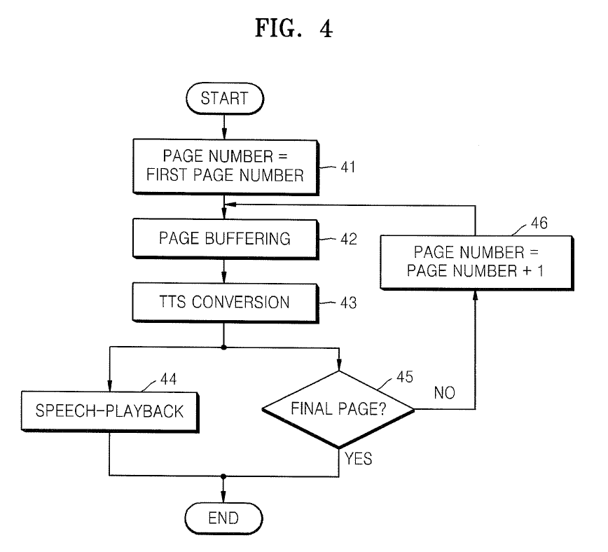

FIG. 4 is a flowchart of another embodiment illustrating detailed operations of the speech-playback operation 24 illustrated in FIG. 2.

FIGS. 5A-5H are examples of a GUI through which the audio-book playback methods illustrated in FIGS. 2 and 4 are implemented.

A page 1 to be first played back as the text-playback in operation 23 is displayed on the LCD (or the text viewer) 13, as illustrated in FIG. 5C.

Referring to FIG. 4, while the audio-book playback apparatus 1 performs the text-playback operation 23 and the speech-playback operation 24 simultaneously, a number of a page to be first played back is set as a page number (operation 41). Referring to FIGS. 5A-5H, in an embodiment of the present general inventive concept, the page number is set to be “1,” because the page to be first played back is page 1.

Text data of the page 1 is buffered in the buffer 15 (operation 42). An amount of data buffered in the operation 42 should be determined within a scope which can guarantee seamless playback of the data.

Therefore, if a size of the text viewer on the LCD 13 is changed, or if a type or a size of a text font displayed is changed, an amount of data to be buffered at once should also be changed. For example, if 50 Korean characters may be displayed at a time on the LCD 13 or per page, the amount of data to be stored in the buffer at one time should be at least 100 bytes, which is equivalent to an amount of text per page. If the size of the text font is doubled, at least 50 bytes of the text data must be buffered since 25 characters can be displayed per page. In this case, buffering 100 bytes of data is equal to buffering an amount of text data worth 2 pages.

TTS conversion is performed on the buffered text data to generate speech data corresponding to the text data (operation 43).

The speech data obtained by TTS conversion in operation 43 is played back via the speaker 17 (operation 44).

The text displayed on the LCD 13 and the voice output via the speaker 17 are synchronized. In the case of FIGS. 5A-5H, a voice saying “rampant” is being output via the speaker 17, while the word “rampant” on the LCD 13 synchronized to the voice is being displayed in a different text size and/or text font so as to be distinguishable from other words.

Once the speech-playback begins in operation 44, the audio-book playback apparatus 1 determines whether the page currently in playback is the last page of the audio-book (operation 45).

If the current page is the last page of the audio-book, the speech-playback operation 44 will be terminated. If the current page is not the last page, the page number will be changed to the next page number (operation 46), and text data of the next page will be buffered. By doing so, once page 1 is played back as illustrated in FIG. 5E, and page 2 may be played back without delay in FIG. 5F. The text data of page 2 is displayed on the LCD 13, and the corresponding speech data synchronized to the text data is output via the speaker 17 as illustrated in FIG. 5F.

If the user wants to cease the speech-playback during the audio-book playback and return to the text-playback mode, the user may switch the speech-playback mode to the text-playback mode by using the user input device 16 as illustrated in FIGS. 5F and 5G.

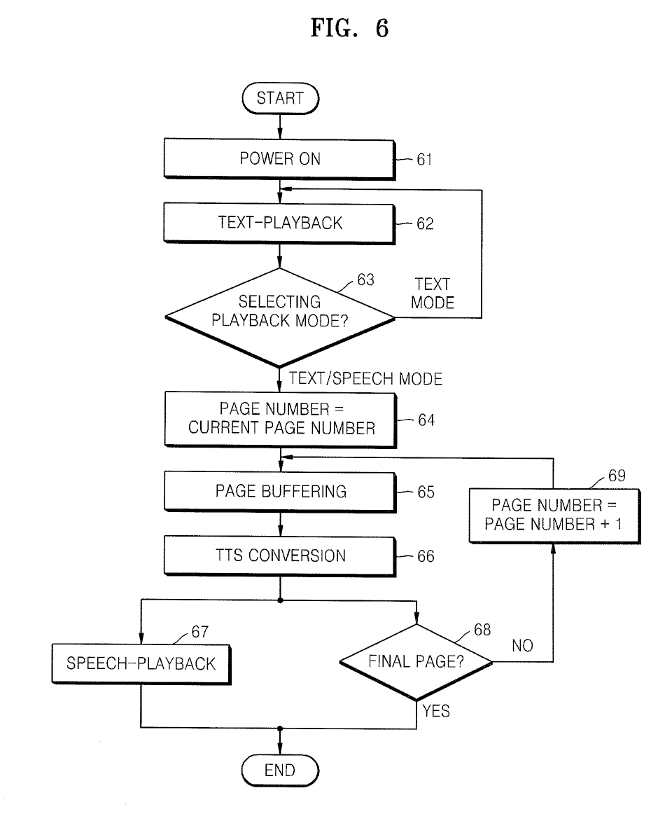

FIG. 6 is a flowchart illustrating an audio-book playback method according to another embodiment of the present general inventive concept.

The embodiment illustrated in FIG. 6 and the embodiment illustrated in FIG. 4 share many common features in terms respective operation details thereof. Therefore, the embodiment illustrated in FIG. 6 will be described by focusing on differences between the embodiments illustrated in FIGS. 4 and 6.

Initially, the user turns the audio-book playback apparatus 1 on (operation 61), and plays back an audio-book in a text-playback mode (operation 62). If the user wants to listen to what he or she was reading while reading the audio-book in a text-only mode, the user should switch the current audio-book playback mode to the text/speech-playback mode by using the user input device 16 (operation 63). When the user selects the text/speech-playback mode, the next operations 64 through 69, which are identical to operations 41 through 46 illustrated in FIG. 4 respectively, are performed. The only difference is that a number of the page being currently played back is set as the page number (operation 64), while in operation 41 the number of the page first played back is set as the page number.

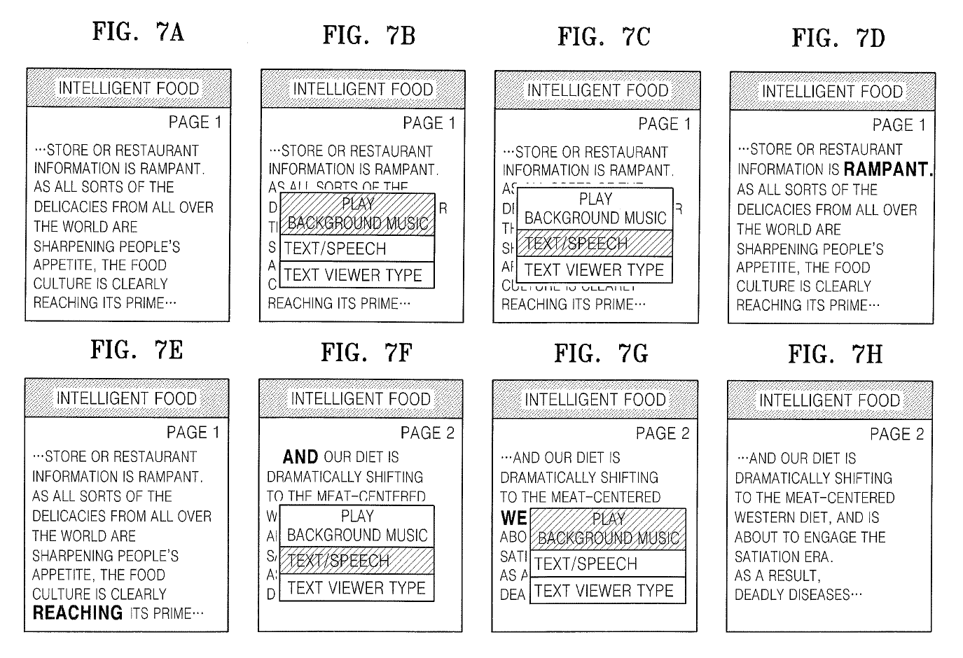

FIGS. 7A-7H are examples of a GUI through which the audio-book playback method illustrated in FIG. 6 is implemented.

Initially, an audio-book is being played back in a text-playback mode as illustrated in FIG. 7A.

If the user wants to listen to content of the audio-book in voice as well as read the text, the user may relocate the cursor in a selecting window to a text/speech-playback mode by pressing the menu key and the directional keys included in the user input device 16, and then press the confirm key as illustrated in FIGS. 7B and 7C. Meanwhile, FIGS. 7F and 7G illustrate a process wherein the user terminates the text/speech-playback method.

The audio-book playback method according to the present general inventive concept can also be embodied as computer-readable codes on a computer-readable recording medium. The computer-readable medium can include a computer-readable recording medium and a computer-readable transmission medium. The computer-readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments for accomplishing the present general inventive concept can be easily construed by programmers of ordinary skill in the art to which the present general inventive concept pertains.

While this present general inventive concept has been particularly illustrated and described with reference to preferred embodiments thereof, it will be understood by those of ordinary skill in the art that various changes in form and details may be made therein without departing from the spirit and scope of the general inventive concept as defined by the appended claims. The preferred embodiments should be considered in descriptive sense only and not for purposes of limitation. Therefore, the scope of the general inventive concept is defined not by the detailed description of the general inventive concept but by the appended claims, and all differences within the scope will be construed as being included in the present general inventive concept.

What is claimed is:

1. An audio-book playback method, comprising:
buffering text data that is to be played back by speech;
converting the buffered text data to speech data;
performing speech-playback by using the speech data; and
buffering next text data that is to be played back by speech.

2. The method of claim 1, wherein the performing of the speech-playback by using the speech data and the buffering of the next text data for continuous playback are performed simultaneously.

3. The method of claim 1, further comprising:
determining whether the data currently in speech-playback is last data, before the buffering of next text data.

4. The method of claim 1, further comprising:
performing TTS (text-to-speech) conversion on the buffered next text data.

5. The method of claim 1, wherein an amount of current data or next data buffered is determined such that seamless playback of the data can be guaranteed.

6. The method of claim 1, wherein an amount of the data buffered in the buffering of text data that is to be played back by speech or the buffering of next text data is determined in consideration of at least one of a storage capacity of the buffer and an amount of data displayable on a display at once.

7. The method of claim 1, further comprising:
performing text-playback,
wherein the performing of the text-playback is synchronized with the performing of the speech-playback.

8. The method of claim 7, wherein text data corresponding to the speech data currently in playback is displayed so as to be distinguishable from other text data.

9. An audio-book playback method, comprising:
selecting an audio-book playback mode; and
based on the selection, performing one of
a text-playback operation, a speech-playback operation and a text and speech-playback operation.

10. The method of claim 9, wherein the speech-playback operation comprises:
buffering text data that is to be played back by speech;
converting the buffered text data to speech data;
performing speech-playback by using the speech data; and
buffering next text data that is to be played back by speech.

11. The method of claim 10, wherein the performing of speech-playback by using the converted speech data and the buffering of next text data are performed simultaneously.

12. The method of claim 10, further comprising:
determining whether the data currently in speech-playback is last data, before the buffering of next text data.

13. The method of claim 10, further comprising:
performing TTS conversion on the buffered next text data.

14. The method of claim 13, wherein the performing of speech-playback by using the speech data and the performing of the TTS conversion on the buffered next text data are performed simultaneously.

15. A computer-readable recordable medium having embodied thereon a computer program to execute a method, the method comprising:
buffering text data that is to be played back by speech;
converting the buffered text data to speech data;
performing speech-playback using the speech data; and
buffering next text data that is to be played back by speech.

16. An audio-book playback apparatus, comprising:
a display to display text data;
a buffer to buffer text data that is to be played back by speech; and
a TTS converter to convert the text data stored in the buffer to speech data,
wherein the audio-book playback apparatus outputs the text data and the speech data simultaneously with buffering text data that is to be played back next.

17. The apparatus of claim 16, wherein an amount of text data stored in the buffer is equal to or greater than an amount of text data to be displayed on the display at once.

18. A portable multimedia playback device, comprising:
a frame; and
an audio-book playback apparatus connected to the frame, the audio-book playback apparatus comprising:
buffering text data that is to be played back by speech;
converting the buffered text data to speech data;
performing speech-playback by using the speech data; and
buffering next text data that is to be played back by speech.

19. An audio-book playback apparatus having a display and a speaker, the apparatus comprising:
a text-viewer function to provide text data to the display to be displayed to a user; and
a book teller function to provide speech data corresponding to the text data to the speaker to be transmitted to the user,
wherein the text data is displayed by the display and the speech data is transmitted by the speaker simultaneously.

20. The apparatus of claim 19, further comprising:
a buffer to buffer a next set of text data and speech data while a previous set of text data and the speech data are being respectively displayed and transmitted.

21. A method of playing back an audio book, the method comprising:
providing text data to be displayed to a user; and
providing speech data corresponding to the text data to be transmitted to the user such that the text data is displayed and the speech data is transmitted simultaneously.
